(19) United States
(12) Patent Application Publication
(10) Pub. No.: US 2025/0384148 A1
(43) Pub. Date: Dec. 18, 2025

(54) Permission Control Method and Apparatus For NFT Circulation Data

(71) Applicant: Feitian Technologies Co., Ltd., Beijing (CN)

(72) Inventors: Baohua MA, Beijing (CN); Zhou LU, Beijing (CN)

(21) Appl. No.: 18/878,909

(22) PCT Filed: Jun. 26, 2023
(86) PCT No.: PCT/CN2023/102465

§ 371 Date: Dec. 26, 2024

(30) Foreign Application Priority Data
Nov. 2, 2022 (CN) 202211360941.7

(51) Int. Cl. G06F 21/60; G06F 21/64

(52) U.S. Cl. CPC G06F 21/604; G06F 21/64

(57) ABSTRACT

A permission control method for NFT circulation data, comprising: receiving an instruction and determining the type; if the instruction is an NFT resource authorization instruction and is verified to be legitimate, calling a smart contract NFT resource authorization interface, and determining whether an authorized address is a target address, and if not, adding a first data structure to the smart contract to complete NFT resource authorization; and, if the instruction is an authorization recovery instruction and is verified to be legitimate, broadcasting the authorization recovery instruction, and, according to a pre-stored smart contract address, querying a smart contract execution code, and, when it is verified, by means of a pre-stored public key of the target address, that a signature of an authorization recovery transaction in the authorization recovery instruction is correct, and it is determined that the NFT resource quantity owned by the target address is sufficient and the authorized address is not the target address, modifying the first data structure according to a first preset mode to complete authorization recovery. By means of the method, a user can recover an authorized permission, thus achieving permission management after resource authorization, and avoiding security risks.

### FIELD OF THE INVENTION

The present invention relates to a method for controlling an authority of NFT circulation data and an apparatus therefor, which belongs to the field of blockchain technology.

### PRIOR ART

NFTs (Non-Fungible Tokens) are blockchain technology based contractual digital certificates.

Currently, NFTs are used by Ethereum as a medium to represent ownership of unique items, and enable tokenization of things like artwork, collectibles, or even real estate. After most of the current NFT markets on Ethereum authorize NFT resources under contracts to addresses specified by the NFT markets, there will be a very serious security hazard due to lack of a post-authorization authority management mechanism.

### SUMMARY OF THE INVENTION

An object of the present invention is to provide a method for controlling an authority of NFT circulation data, in which a user can withdraw authorized rights to achieve the post-authorization authority management of resources, thereby avoiding security hazards.

According to the first aspect of the present invention, there is provided a method for controlling an authority of NFT circulation data, which includes:
Step S1: receiving, by a server, an instruction initiated by a client;
Step S2: judging, by the server, the type of the instruction, executing Step S3 if the instruction is an NFT resource authorization instruction, and executing Step S5 if the instruction is an authorization withdrawal instruction;
Step S3: verifying, by the server, the legitimacy of the NFT resource authorization instruction, calling a smart contract NFT resource authorization interface and executing Step S4 if the verification passes, otherwise, returning an error message and executing Step S1;
Step S4: judging, by the server, whether an authorized address obtained from the NFT resource authorization instruction is a target address, if not, adding a first data structure to a smart contract, completing an NFT resource authorization, recording an authorization log, and executing Step S10, and if yes, recording an error log and executing Step S1;
Step S5: verifying, by the server, the legitimacy of the authorization withdrawal instruction, if the verification passes, broadcasting the authorization withdrawal instruction, querying a smart contract execution code according to a pre-stored smart contract address, and executing Step S6; otherwise, returning an error message and executing Step S1;
Step S6: verifying, by the server, a signature of an authorization withdrawal transaction in the authorization withdrawal instruction using a pre-stored public key of the target address, if the verification passes, executing Step S7, otherwise, returning an error message and executing Step S1;
Step S7: obtaining, by the server, an amount of additional resources and an amount of NFT resources owned by the target address from the authorization withdrawal instruction, and checking whether the amount of NFT resources owned by the target address is sufficient according to the amount of additional resources; if the amount of NFT resources owned by the target address is sufficient, executing Step S8, otherwise, returning an error message and executing Step S1;
Step S8: judging, by the server, whether an authorized address obtained from the authorization withdrawal instruction is the target address; if not, modifying the first data structure according to a first preset mode, completing an authorization withdrawal, recording an authorization withdrawal log, and executing Step S9, and if yes, recording an error log and executing Step S1;
Step S9: deducting, by the server, the amount of additional resources from the amount of NFT resources owned by the target address to generate a corresponding authorization event, recording an authorization withdrawal log, and executing Step S10; and
Step S10: synchronizing, by the server, information generated by processing the instructions to other servers on the same blockchain, and executing Step S1.

According to the second aspect of the present invention, there is provided an apparatus for controlling an authority of NFT circulation data, which includes:
an instruction receiving module configured to receive an instruction initiated by a client;
an instruction judging module configured to judge the type of the instruction, trigger a first verification module if the instruction is an NFT resource authorization instruction, and trigger a second verification module if the instruction is an authorization withdrawal instruction;
the first verification module configured to verify the legitimacy of the NFT resource authorization instruction; if the verification passes, call a smart contract NFT resource authorization interface and trigger a resource authorization module, otherwise, return an error message and trigger the instruction receiving module;
the resource authorization module configured to judge whether an authorized address obtained from the NFT resource authorization instruction is a target address; if not, add a first data structure to a smart contract, complete an NFT resource authorization, record an authorization log, and trigger an instruction information synchronizing module; if yes, record an error log and trigger the instruction receiving module;
the second verification module configured to verify the legitimacy of the authorization withdrawal instruction; if the verification passes, broadcast the authorization withdrawal instruction, query a smart contract execution code according to a pre-stored smart contract address, and trigger a signature verifying module; otherwise, return an error message and trigger the instruction receiving module;
the signature verifying module configured to verify a signature of an authorization withdrawal transaction in the authorization withdrawal instruction using a pre-stored public key of the target address; if the verification passes, trigger a resource judging module, otherwise, return an error message and trigger the instruction receiving module;
the resource judging module configured to obtain an amount of additional resources and an amount of NFT resources owned by the target address from the authorization withdrawal instruction; check whether the amount of NFT resources owned by the target address is sufficient according to the amount of additional resources; if the amount of NFT resources owned by the target address is sufficient, trigger an authorization withdrawal module, otherwise, return an error message and trigger the instruction receiving module;
the authorization withdrawal module configured to judge whether an authorized address obtained from the authorization withdrawal instruction is the target address; if not, modify the first data structure according to a first preset mode, complete an authorization withdrawal, record an authorization withdrawal log, trigger a resource amount deducting module, and if yes, record an error log and trigger the instruction receiving module;
the resource amount deducting module configured to deduct the amount of additional resources from the amount of NFT resources owned by the target address to generate a corresponding authorization event, record an authorization withdrawal log, and trigger the instruction information synchronizing module; and
the instruction information synchronizing module configured to synchronize information generated by processing the instructions to other servers on the same blockchain, and trigger the instruction receiving module.

According to the third aspect of the present invention, there is provided a computer-readable storage medium having a computer program stored thereon, which, when executed by a processor, implements the steps of any one of the methods described above.

According to the fourth aspect of the present invention, there is provided a server, including a memory, a processor, and a computer program stored on the memory and executable by the processor, wherein the processor, when executing the computer program, implements the steps of any one of the methods described above.

According to the present invention, a user can withdraw authorized rights to achieve post-authorization authority management of resources, thereby avoiding security hazards.

### BRIEF DESCRIPTION OF THE DRAWINGS

In order to more clearly illustrate the technical solutions in embodiments of the present invention or in prior art, the drawings needed in the embodiments or the prior art will be briefly described below. It will be obvious that the drawings in the following description are merely some of the embodiments of the present application, and those skilled in the art can obtain other drawings according to these drawings without creative work.

FIG. 1 to FIG. 3 show schematic flow diagrams of a method for controlling an authority of NFT circulation data provided in embodiments of the present invention.

### DETAILED DESCRIPTION OF PREFERRED EMBODIMENTS

In order to make the objects, technical solutions, and advantages of the present application clearer, embodiments of the present application will be further described in detail below in conjunction with the drawings.

When the following description refers to the drawings, unless otherwise indicated, the same numbers in different drawings refer to the same or similar elements. Embodiments described in the following exemplary embodiments do not represent all embodiments consistent with the present application. Rather, they are merely examples of apparatuses and methods consistent with some aspects of the present application as detailed in the appended claims.

In the description of the present application, it should be understood that the terms “first”, “second”, etc., are used for descriptive purposes only and are not to be construed as indicating or implying relative importance. Those skilled in the art may understand the specific meanings of these terms in the present application based on specific circumstances. In addition, in the description of the present application, the term “plurality” refers to two or more, unless otherwise specified. The term “and/or” describes the association relationship of association objects, indicating that three relationships may exist, for example, A and/or B can represent the following three scenarios: A exists alone, A and B exist simultaneously, or B exists alone. The character “/” generally indicates an “or” relationship between the objects before and after it.

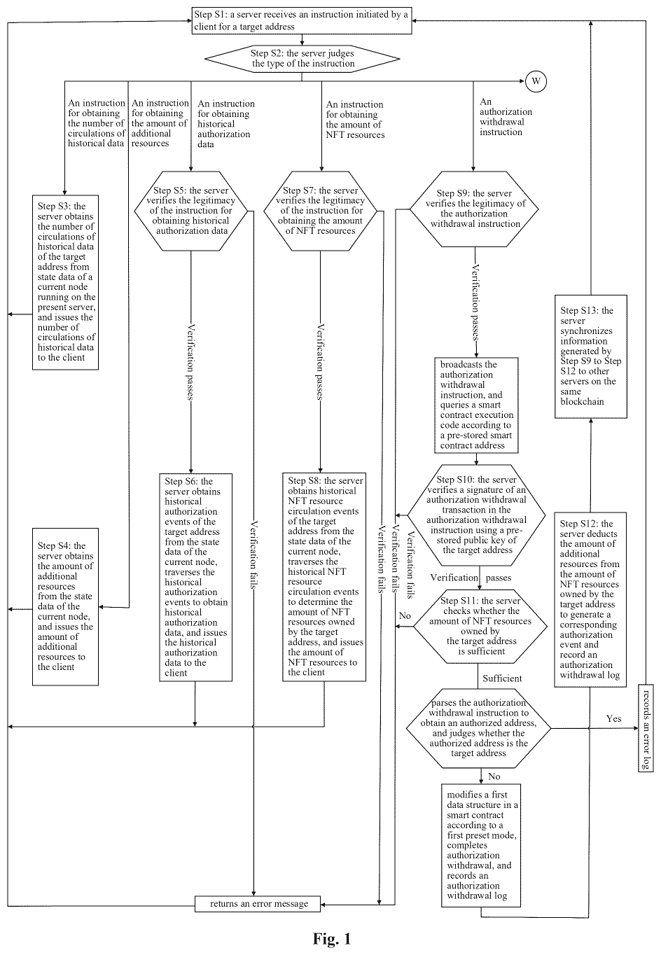

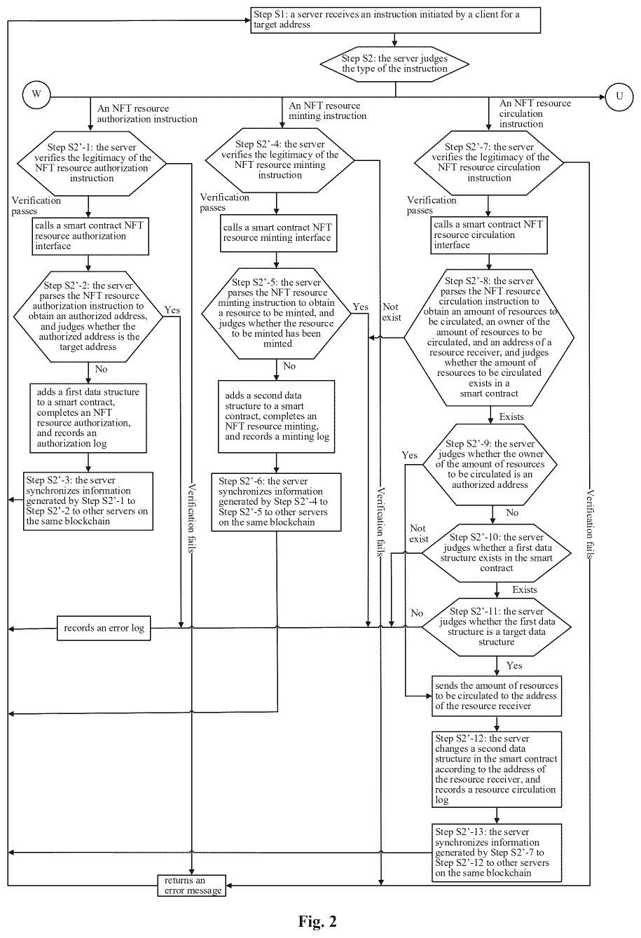

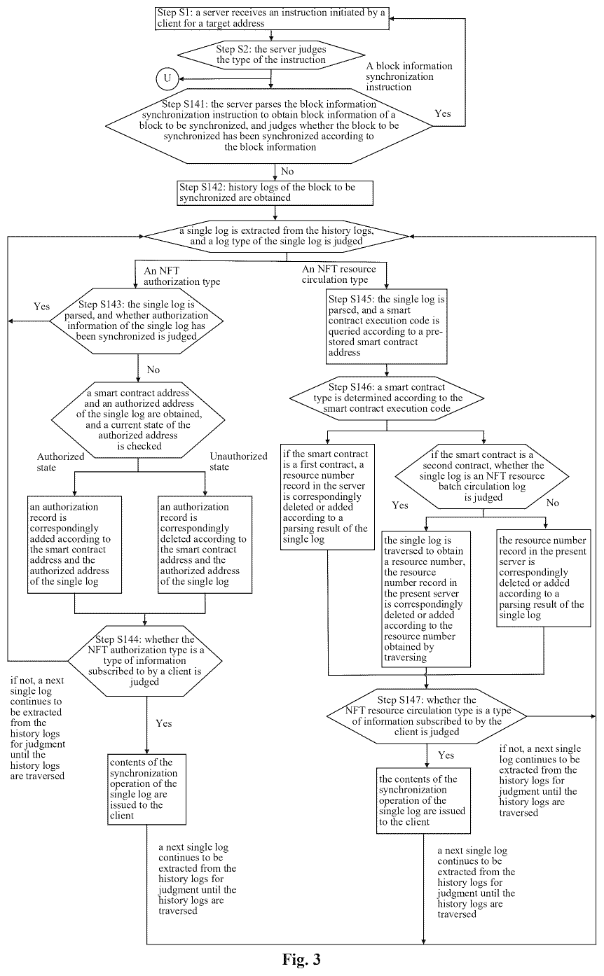

A method for controlling an authority of NFT circulation data provided in the present invention will be described in detail in conjunction with FIG. 1 to FIG. 3.

Please refer to FIG. 1 to FIG. 3, they show a schematic flow diagram of a method for controlling the authority of NFT circulation data provided in an embodiment of the present invention.

As shown in FIG. 1 to FIG. 3, the method provided in the embodiment of the present invention includes the following steps:

Step S1: a server receives an instruction initiated by a client for a target address.

A server in the present application encompasses blockchain middleware, miner nodes, or validation nodes.

In practice, a server may receive a plurality of instructions originating from different addresses. To clarify the method for controlling the authority provided by the present invention, the embodiment will be described as an example that a server receives an instruction from the same address (i.e., a target address).

The target address may be address A, address B or the like.

For example, the target address is 0x4196eff51e48f88c1393c3f0d5f5c1941b94ed7c.

Step S2: the server judges the type of the instruction; if the instruction is an instruction for obtaining the number of circulations of historical data, executes Step S3; if the instruction is an instruction for obtaining an amount of additional resources, executes Step S4; if the instruction is an instruction for obtaining historical authorization data, executes Step S5; if the instruction is an instruction for obtaining an amount of NFT resources, executes Step S7; if the instruction is an authorization withdrawal instruction, executes Step S9.

Step S3: the server obtains the number of circulations of historical data of the target address from state data (or status data) of a current node running on the present server, issues the number of circulations of historical data to the client, then executes Step S1.

For example, the state data of the current node is:

```
[
  {
    “0x4196eff51e48f88c1393c3f0d5f5c1941b94ed7c”:{
      “nonce”:1000
    }
....
]
```

The number of circulations of historical data obtained from the above state data instance is 1000.

Step S4: the server obtains the amount of additional resources from the state data of the current node, issues the amount of additional resources to the client, then executes Step S1.

In this step S4, there may be one grade or multiple grades of the amount of additional resources issued by the server to the client. In the case of only one grade of the amount of additional resources issued, the server will deduct the grade of the amount of resources directly from the amount of resources owned by the target address when authorization withdrawal is carried out. In the case of multiple grades of the amount of additional resources issued, the user may select an affordable target amount of additional resources therefrom, and when authorization withdrawal is carried out, the server will deduct the target amount of additional resources selected by the user from the amount of resources owned by the target address.

The amount of additional resources issued by the server to the client, for example, is:

```
{
  “fastestFee”:15,
  “halfHourFee”:3.5,
  “hourFee”:2.4
}
```

In a preferred embodiment, the amount of additional resources may not be issued by the server, but rather the user sets an affordable amount of additional resources as the target amount of additional resources to be deducted through the client.

Step S5: the server verifies the legitimacy of the instruction for obtaining historical authorization data; if the verification passes, executes Step S6, otherwise, returns an error message then executes Step S1.

Step S5 may specifically include:

the server calculates an owner public key that triggers the instruction for obtaining historical authorization data through signature data of the instruction for obtaining historical authorization data, verifies a signature of the instruction for obtaining historical authorization data using the owner public key, if the verification passes, executes Step S6, otherwise, returns an error message then executes Step S1.

For example, the signature data of the instruction for obtaining historical authorization data is:
0x7b2276657273696f6e223a227832353531392d7873616c736132302d706f6c79313330352 22c226e6f6e6365223a2238547033356c636570623137452b5a2f57356949546d445a6539347364 463034222c22657068656d5075626c69634b6579223a226861513555762f553253304169563933 6d43386a4a636c78317061307173487a766b4655496b336a3848673d222c226369706865727465 7874223a2257513435306f5479333133344f5865704a3835574673454b5748306c545741594c646 c576f734276577935517a4b696d63775a494151346772304d306f742f3955574c63706963654e2f 31312f6a4e644274334b722f4344745653567a784c58694b346e39492b6b4d7238456a43662b495 54c385a7344544d2f6f3d227d,
in which “r, s, v” information may be obtained according to the signature data, and the owner public key that triggers the instruction for obtaining historical authorization data may be deduced based on the obtained “r, s, v” information.

The owner public key that triggers the instruction for obtaining historical authorization data, for example, is:
0x033d699446e69a71778e4dc5eadd46f789329dfa7ed61dfa0ebf79eee05fc0603f.

Step S6: the server obtains historical authorization events of the target address from the state data of a current node, traverses the historical authorization events to obtain historical authorization data, issues the historical authorization data to the client, then executes Step S1.

Specifically, for the step of traversing the historical authorization events to obtain historical authorization data, and issuing the historical authorization data to the client, the method includes:
parsing the historical authorization events, and de-duplicating the parsed historical authorization events to obtain de-duplicated historical authorization events;
extracting a single authorization event from the de-duplicated historical authorization events; judging whether a smart contract address of the single authorization event and an authorized address are saved as historical authorization data; if the smart contract address and the authorized address are not saved, checking a current state of the authorized address; if the current state is an authorized state, saving the smart contract address and the authorized address as historical authorization data correspondingly; if the current state is an unauthorized state, continuing to extracting a next single authorization event from the de-duplicated historical authorization events for judgment;
if the smart contract address and the authorized address are saved, continuing to extract a next single authorization event from the de-duplicated historical authorization events for judgment; and
issuing all historical authorization data saved to the client when the de-duplicated historical authorization events are traversed.

The smart contract address of the single authorization event, for example, is: 0x1AF7A7555263F275433c6Bb0b8FdCD231F89B1D8.

The authorized address, for example, is 0x0cf0aab68432a3710ecbf2f1b112a11cee31a83c.

Step S7: the server verifies the legitimacy of the instruction for obtaining the amount of NFT resources; if the verification passes, executes Step S8, otherwise, returns an error message then executes Step S1.

The process of verifying the legitimacy of the instruction for obtaining the amount of NFT resources may specifically refer to Step S5, which will not be repeated here.

Step S8: the server obtains historical NFT resource circulation events of the target address from the state data of the current node, traverses the historical NFT resource circulation events to determine the amount of NFT resources owned by the target address, and issues the amount of NFT resources to the client.

Where for the step of traversing the historical NFT resource circulation events to determine the amount of NFT resources owned by the target address, and issuing the amount of NFT resources to the client, the method specifically includes:
a smart contract execution code is queried according to a pre-stored smart contract address;
the smart contract address pre-stored by the server, for example, is: 0x1AF7A7555263F275433c6Bb0b8FdCD231F89B1D8;
the smart contract execution code, for example, is:
60806040526040516109943803806109948339818101604052606081101561002657600080 fd5b81516020830151604080850180519151939592948301929184640100000000821115610051 57600080fd5b90830190602082018581111561006657600080fd5b8251640100000000811182820 18810171561008057600080fd5b82525081516020918201929091019080838360005b838110156 100ad578181015183820152602001610095565b50505050905090810190601f1680156100da578 0820380516001836020036101000a031916815260200191505b5060408181527f6569703139363 72e70726f78792e696d706c656d656e746174696f6e0000000082525190819003601c0190208693 5084925060008051602061093983398151915260001990910114905061013157fe5b6101438260 01600160e01b0361026516565b8051156101fb576000826001600160a01b031682604051808280 519 . . .
a smart contract type is determined based on the smart contract execution code; if a smart contract is a first contract, the historical NFT resource circulation events are parsed, and event deduplication and resource number deduplication are performed on the parsed historical NFT resource circulation events to obtain a first deduplication result;
the first contract is specifically ERC721 contract.

A single NFT resource circulation event is extracted from the first deduplication result, and whether a related object corresponding to the single NFT resource circulation event is the target address is judged; if yes, whether the resource circulation amount of the single NFT resource circulation event is saved as historical resource circulation data is judged, if the resource circulation amount of the single NFT resource circulation event is not saved, the resource circulation amount is saved as historical resource circulation data; if the resource circulation amount of the single NFT resource circulation event is saved, a next single NFT resource circulation event continues to be extracted from the first deduplication result for judgment;
in which the related object may be an NFT resource sender, or an NFT resource receiver; and
if not, a next single NFT resource circulation event is extracted from the first deduplication result for judgment.

When the first deduplication result is traversed, the amount of NFT resources owned by the target address is obtained by computation based on all historical resource circulation data saved, and the amount of NFT resources is issued to the client.

The amount of NFT resources owned by the target address, for example, is:

```
[
  {
    “0x4196eff51e48f88c1393c3f0d5f5c1941b94ed7c”:[
      {
        “address”:“0x1AF7A7555263F275433c6Bb0b8FdCD231F89B1D8”,
        “tokenId”:445
      },
...
    ],
...
  }
]
```

After the smart contract type is determined based on the smart contract execution code, the method further includes:
if the smart contract is a second contract, NFT resource circulation events of the target type are obtained from the historical NFT resource circulation events and parsed, and event deduplication and resource number deduplication are performed on the parsed NFT resource circulation events of the target type to obtain a second deduplication result;
the second contract is specifically ERC1155 contract.

The NFT resource circulation events of the target type are specifically single NFT resource circulation events, or bulk NFT resource circulation events;
a single NFT resource circulation event is extracted from the second deduplication result, the amount of remaining resources in the contract corresponding to the single NFT resource circulation event is obtained; whether the amount of remaining resources is greater than zero is judged; if yes, the amount of remaining resources is issued as the amount of NFT resources owned by the target address to the client and traversing ends, and if not, a next single NFT resource circulation event continues to be extracted from the second deduplication result to obtain the amount of remaining resources for judgment until all NFT resource circulation events in the second deduplication result are traversed.

For example, the amount of remaining resources in the contract is:

```
[
  {
    “0x1AF7A7555263F275433c6Bb0b8FdCD231F89B1D8”:[
      445,
      23,
      2
    ],
...
  }
]
```

In a preferred embodiment, the method further includes:
when the amount of remaining resources in the contract corresponding to each NFT resource circulation event in the second deduplication result is equal to zero, a response that no NFT resource exits at the target address is returned to the client.

Step S9: the server verifies the legitimacy of the authorization withdrawal instruction, if the verification passes, broadcasts the authorization withdrawal instruction, queries the smart contract execution code according to the pre-stored smart contract address, executes Step S10, otherwise, returns an error message then executes Step S1.

The authorization withdrawal instruction is composed of parameters such as the target address, the smart contract address, the number of circulations of historical data of the target address, the target amount of additional resources, the amount of NFT resources owned by the target address, the authorized address, etc.

The server finds an authorization withdrawal interface through the queried execution code to withdraw authorization.

The process of verifying the legitimacy of the authorization withdrawal instruction may specifically refer to Step S5, which will not be repeated here.

Step S10: the server verifies a signature of an authorization withdrawal transaction in the authorization withdrawal instruction using a pre-stored public key of the target address, if the verification passes, executes Step S11, otherwise, returns an error message then executes Step S1.

Step S10 specifically includes:
Step S101: the server extracts signature information of the authorization withdrawal transaction from the authorization withdrawal instruction, and decrypts the signature information using the pre-stored public key of the target address to obtain a first hash value;
the signature information of the authorization withdrawal transaction, for example, is:
0x7b2276657273696f6e223a227832353531392d7873616c736132302d706f6c79313330352 22c226e6f6e6365223a227375637a766a41676e68394c534f3467337365486d414d66375a594667 734533222c22657068656d5075626c69634b6579223a22307841506c314a616439347068783558 662f4c58587064364c6e58482f5545645349666c4f7335687053673d222c2263697068657274657 874223a2253425a7561546a434c4e31445159342b624a4e6a5543653075744c734978524d485444 535962596d35666b54364b564679676d6e5655442f516679453266754e6c675639743369313468 64354c4935786b357837776562486a514234614739515773497476726957432b34417230487439 30476b4d366f5048446f2b664a6957716f6e754b3470706b587044536b4b6f4b7a32462f7676512f 6731735a72464a533838342b397073472f56485563415a37654f2b456f2f35336e5765653030526 66c485a386952633973454d6765487736395a6b645270732f47494f56794733505474444d367a35 416b725238595876786e75475130566b536656665433584c35447250766d47744a4c4f4846456b 2f2f74792b425a4c69545655773656544d6234336e6f7a4f4b6c63434558584b497555634d2f4355 565838654f755033744f796b42327a466c465a6965754c6357576a6b50754d6254316842697a4e6 c3437576e542b50335646795844767a6f516d4563582f6a6a4c67776d6238365276527374423357 676c70576e494d6f6f717849736c744c6a372b31385038654177544d6455666e4a5643483071794 a596f4a7142563775654e5668716a64796a346e58745968684f6233396744345451316642576b4d 486763634147487045354426386d43557576726535523474354b384f576e6e6b4b665767416856 554d6b375a396c6a66736c37366967327a2f6a6c4c55595745542b2b6f307444307a2b7a7449387 9743067796277764e36686b426939534447344652456c644f344c5375733635627a706d7a6f626d 59325a56424c4c4657382f53736d71543842304567227d.

The public key of the target address, for example, is 0x033d699446e69a71778e4dc5eadd46f789329dfa7ed61dfa0ebf79eee05fc0603f.

Step S102: the server performs a hashing operation on text information of the authorization withdrawal transaction in the authorization withdrawal instruction to obtain a second hash value;
the text information of the authorization withdrawal transaction, for example, is:

```
  {
    “from”:“0x4196Eff51e48f88C1393C3f0d5F5C1941b94eD7c”,
    “to”:“0x1AF7A7555263F275433c6Bb0b8FdCD231F89B1D8”,
    “nonce”:1000,
    “gasprice”:“0x14dc9380”,
“data”:“0xa22cb4650000000000000000000000000cf0aab68432a3710ecbf2f1b112a11cee31a83c
0000000000000000000000000000000000000000000000000000000000000000”,
    “r”:“0xb5a0be24a1565e3a316b6cacd3403c4f8c44b66e6cab0fe39d1c45de382e81b3”,
    “s”:“0x178a46d58d8238399f509c77d121f9ff74a6fea1acab84a805fcf1de8b3eb7b7”,
    “v”:1
  }
```

Step S105: the server judges whether the first hash value is identical with the second hash value, if the first hash value and the second hash value are identical, passes the verification, executes Step S11, otherwise, returns an error message then executes Step S1.

Step S11: the server checks whether the amount of NFT resources owned by the target address is sufficient, if the amount of NFT resources owned by the target address is sufficient, calls a smart contract authorization withdrawal method based on the smart contract execution code to withdraw authorization, executes Step S12, otherwise, returns an error message then executes Step S1.

Specifically, for the step that the server checks whether the amount of NFT resources owned by the target address is sufficient, the method includes:
the server obtains the target amount of additional resources to be deducted and the amount of NFT resources owned by the target address from the authorization withdrawal instruction, judges whether the amount of NFT resources owned by the target address is greater than the target amount of additional resources, if yes, calls the smart contract authorization withdrawal method based on the smart contract execution code to withdraw authorization, executes Step S12, otherwise, returns an error message then executes Step S1.

When there are multiple grades of the amount of additional resources issued by the server to the client, the target amount of additional resources is an affordable amount of additional resources selected by the client from the multiple grades of the amount of additional resources.

The target amount of additional resources, for example, is: “halfHourFee”:3.5.

In addition, when there is only one grade of the amount of additional resources issued by the server to the client, the amount of additional resources corresponding to the grade is the target amount of additional resources.

Where for the step of calling the smart contract authorization withdrawal method based on the smart contract execution code to withdraw authorization, the method specifically includes:
parsing the authorization withdrawal instruction to obtain the authorized address, and judging whether the authorized address is the target address; if not, modifying a first data structure in the smart contract according to a first preset mode, completing authorization withdrawal, and recording an authorization withdrawal log; if yes, recording an error log, then executing Step S1.

Assuming that the target address is A, the authorized address is C, and A withdraws NFT resource authorization to C, the server modifies the first data structure in the contract according to the first preset mode. The modified first data structure is specifically [A][C]=false.

Step S12: the server deducts the amount of additional resources from the amount of NFT resources owned by the target address to generate a corresponding authorization event, records an authorization withdrawal log, then executes Step S13.

In a preferred embodiment, Step S12 specifically includes:
the server deducts the target amount of additional resources from the amount of NFT resources owned by the target address to generate a corresponding authorization event, then executes Step S13.

When there are multiple grades of the amount of additional resources issued by the server, the server can deduct the target amount of additional resources selected by the user from the amount of NFT resources owned by the target address when performing authorization withdrawal.

Step S13: the server synchronizes information generated by Step S9 to Step S12 to other servers on the same blockchain, then executes Step S1.

The information on the servers on the same blockchain remains synchronized, and when the information on one of the servers' changes, the remaining servers will also be updated synchronously. In the process described above, all the information generated after the authorization withdrawal instruction is uploaded to the chain (starting at Step S9) is synchronized to other servers on the same blockchain.

Specifically, when the process goes to Step S9, the authorization withdrawal instruction is uploaded to the chain, and the information that needs to be synchronized to other servers includes the legitimacy verification process and verification result of the authorization withdrawal instruction, the signature verification process and verification result of the authorization withdrawal transaction, the process and result of judging whether the amount of NFT resources is sufficient, the authorization withdrawal process, and the NFT resource deduction result.

In addition, after the authorization withdrawal instruction is uploaded to the chain, the verification process and the unsuccessful verification result are also synchronized to other servers on the same blockchain if there is any unsuccessful information verification.

In a preferred embodiment, Step S2 further includes:
if the instruction is an NFT resource authorization instruction, Step S2′-1 is executed; if the instruction is an NFT resource minting instruction, Step S2′-4 is executed; if the instruction is an NFT resource circulation instruction, then Step S2′-7 is executed.

Step S2′-1: the server verifies the legitimacy of the NFT resource authorization instruction, if the verification passes, calls a smart contract NFT resource authorization interface then executes Step S2′-2, otherwise, returns an error message then executes Step S1.

The smart contract NFT resource authorization interface, for example, is:
Function: setApprovalForAll(address operator, bool approved)

Step S2′-2: the server parses the NFT resource authorization instruction to obtain the authorized address, judges whether the authorized address is the target address, if not, adds a first data structure to the smart contract, completes an NFT resource authorization, records an authorization log, then executes Step S2′-3, if yes, records an error log then executes Step S1.

Assuming that the target address is A, the authorized address is C, and A authorizes NFT resources in a contract B to C, the first data structure added in the smart contract is specifically [A][C]=true.

In a preferred embodiment, there is also a case where a certain address is authorized again after authorization is withdrawn, Step S2′-2 specifically includes:
Step S2′-21: the server judges whether the authorized address obtained from the NFT resource authorization instruction is the target address; if not, judges whether a target data structure exists in the smart contract, if the target data structure exists, executes Step S2′-22, and if the target data structure does not exist, executes Step S2′-23; if yes, records an error log then executes Step S1;
Step S2′-22: the server modifies the target data structure according to a second preset mode to obtain a first data structure, completes an NFT resource authorization, records an authorization log, then executes Step S2′-3;
Step S2′-23: the server adds the first data structure to the smart contract, completes an NFT resource authorization, records an authorization log, then executes Step S2′-3.

The above steps are illustrated by way of example:

If C is authorized again after authorization is withdrawn, then when the target data structure [A][C]=false exists in the smart contract, the target data structure is modified in the second preset mode to obtain the first data structure [A][C]=true, and the authorization is completed again; when the target data structure [A][C]=false does not exist in the smart contract, the first data structure [A][C]=true is added directly to the contract and the authorization is completed again.

Step S2′-3: the server synchronizes information generated by Step S2′-1 to Step S2′-2 to other servers on the same blockchain, then executes Step S1.

Information to be synchronized may specifically refer to step S13, which is not repeated here.

In other embodiments, when the target address authorizes NFT resources in the same contract to multiple different addresses, Step S2′-2 to Step S2′-3 are executed once for the different authorized addresses, separately.

For example, the target address A authorizes the NFT resources in the contract B to both the authorized address C and the authorized address C′, and Step S2′-2 to Step S2′-3 are executed once when the NFT resource is authorized to C; and Step S2′-2 to Step S2′-3 are executed once again when the NFT resource is authorized to C′.

In other embodiments, when the target address authorizes NFT resources in different contracts to the same address, Step S2′-1 to Step S2′-3 are performed once for the different contracts, separately.

Further authorization cases will not be enumerated here.

Step S2′-4: the server verifies the legitimacy of the NFT resource minting instruction; if the verification passes, calls a smart contract NFT resource minting interface then executes Step S2′-5; otherwise, returns an error message then executes Step S1.

The smart contract NFT resource minting interface, for example, is:
Function: mint (uint256 tokenId, uint8 v, bytes32 r, bytes32 s, tuple[ ]_fees, string tokenURI)

Step S2′-5: the server parses the NFT resource minting instruction to obtain a resource to be minted; judges whether the resource to be minted has been minted; if not, adds a second data structure to the smart contract, completes NFT resource minting, records a minting log, then executes Step S2′-6; if yes, records an error log then executes Step S1.

Assuming that the resource to be minted at the target address A is D, the second data structure added to the smart contract B is specifically [D]=A.

Step S2′-6: the server synchronizes information generated by Step S2′-4 to Step S2′-5 to other servers on the same blockchain, then executes Step S1.

Information to be synchronized may specifically refer to step S13, which is not repeated here.

Step S2′-7: the server verifies the legitimacy of the NFT resource circulation instruction; if the verification passes, calls a smart contract NFT resource circulation interface then executes Step S2′-8; otherwise, returns an error message then executes Step S1.

The smart contract NFT resource circulation interface, for example, is:
Function: Transfer (address from, address to, uint256 tokenId)

Step S2′-8: the server parses the NFT resource circulation instruction to obtain an amount of resources to be circulated, an owner of the amount of resources to be circulated, and an address of a resource receiver, judges whether the amount of resources to be circulated exists in the smart contract, if the amount of resources to be circulated exists, executes Step S2′-9, if the amount of resources to be circulated does not exist, records an error log then executes Step S1.

Step S2′-9: the server judges whether the owner of the amount of resources to be circulated is an authorized address, if not, executes Step S2′-10, if yes, sends the amount of resources to be circulated to the address of the resource receiver then executes Step S2′-12.

The address of the resource receiver, for example, is:
0x247ca33a0b2358c52bc48df85fc9ce8098049711.

Step S2′-10: the server judges whether a first data structure exists in the smart contract; if the first data structure exists, executes Step S2′-11; if the first data structure does not exist, records an error log then executes Step S1.

Step S2′-11: the server judges whether the first data structure is a target data structure; if yes, sends the amount of resources to be circulated to the address of the resource receiver then executes Step S2′-12; if not, records an error log then executes Step S1.

Illustrative example: assuming that A authorizes NFT resources in the contract B to C, the target data structure refers to [A][C]=true.

Step S2′-12: the server changes the second data structure in the smart contract according to the address of the resource receiver, records a resource circulation log, then executes Step S2′-13.

Assuming that the address of the resource receiver is E, the changed second data structure is specifically [D]=E.

Step S2′-13: the server synchronizes information generated by Step S2′-7 to Step S2′-12 to other servers on the same blockchain, then executes Step S1.

Information to be synchronized may specifically refer to Step S13, which is not repeated here.

In a preferred embodiment, Step S2 specifically includes:
if the instruction is a block information synchronization instruction, Step S14 is executed:
the server parses the block information synchronization instruction to obtain block information of a block to be synchronized, judges whether the block to be synchronized has been synchronized according to the block information, if not, obtains and parses history logs of the block to be synchronized, performs information synchronization on the block to be synchronized according to a parsing result, executes Step S1, and if yes, executes Step S1.

The server determines whether the block to be synchronized has been synchronized by comparing block heights and hash values: when a local synchronized block height is greater than or equal to a block height obtained by parsing and a local synchronized block hash value is equal to a block hash value obtained by parsing, it is determined that the block to be synchronized has been synchronized, otherwise, it is determined that the block to be synchronized has not been synchronized.

The block information, for example, is:

```
  {
    “hash”:“0x06ec37a04db291223926bd6e67309e8be0b80e8db97bdd8ff6395db8db7f0e7c”,
      “parentHash”:“0x245d484effd96504343604b793b3d490c03deeda6646fe564087ef9bdc92c3d9”,
    “number”:11111,
    “timestamp”:1648548227,
    “transactions”:[
      {
              “hash”:“0x144376cc3a270dfe00cf6f039a33aac2b11cf74f6246aa82f0966679cda6c9f6”,
          “from”:“0xe3A1A65fC970C46b8f3fFa6615bb3F28b52036f3”,
          “to”:“0x2d53FC29a46e6181aDd77a8B612A42526ccA5638”,
          “value”:“0x038d7ea4c68000”,
          “nonce”:22,
          “gasprice”:“0x9380”,
          “data”:“0x”,
          “r”:“0x8ce0b4b84e99cc84c09883ca75fc47c77137e82689cf2b957ecb04eaf8e8c694”,
          “s”:“0x35235245d655f7d8b89f998cf0d7c86867470535f5b2ad1cf640014e4a8276c1”,
          “v”:1
          },
          {
            “hash”:“0x28cc94ad86bd5c1b8487a85896475d4b6e1aec110a4c4d921b7c4d0c1a0b5631”,
            “from”:“0x9226f7dF5E316df051F0490cE3b753c51695D0Bb”,
            “to”:“0xcE4dE8C8b755B5DbaDE72dF45645c5706f686550”,
            “value”:“0x00”,
            “nonce”:361,
            “gasprice”:“0x44dc2530”,
“data”:“0x156e29f60000000000000000000000008d38621391d663332ad24cf895b8f59f0edfd9330000000000
00000000000000000000000000000000000000000000000000000400000000000000000000000000000000000
00000000000000000000000002710”,
            “r”:“0x8ca50ddb979f388431242f4ef5aa4f7a9da98a2c27f551990bca48bff65c3b14”,
            “s”:“0x34ef9e4012011265ae8ca52d10c8e51d80b7b9f944247239fac46e4cacbed6f6”,
            “v”:44
          },
          {
            “hash”:“0xeb7f491d466f5bb76d49ed226e4051e3bd1be0603ebbca227d82c2999c13274f”,
            “from”:“0x87c9B02A10eC2CB4dcB3b2e573e26169CF3cd9Bf”,
            “to”:“0xf8514CAF373E1d0838fAeC963f8C77a50BC8558C”,
            “value”:“0x016345785d8a0000”,
            “nonce”:14618,
            “gasprice”:“0x13dc9380”,
            “data”:“0x”,
            “r”:“0xf1c08809d75e8cf5c2376c07282d5e13d6ffa4256b7ee80da8a2031c677ab4bd”,
            “s”:“0x55fbbd58138eb53c9aafef399fb40d029ae5f355e04d275a33be48874675dae1”,
            “v”:43
          },
  ....
        ]
  }
```

In a preferred embodiment, Step S14 specifically includes:
Step S141: the server parses the block information synchronization instruction to obtain block information of a block to be synchronized, judges whether the block to be synchronized has been synchronized according to the block information, if not, then executes Step S142; if yes, then executes Step S1;
Step S142: history logs of the block to be synchronized are obtained, a single log is extracted from the history logs, and a log type of the single log is judged;
Step S143: if the log type is an NFT authorization type, the single log is parsed, and whether authorization information of the single log has been synchronized is judged; if not, a smart contract address and an authorized address of the single log are obtained, a current state of the authorized address is checked, if the current state is the authorized state, an authorization record is correspondingly added according to the smart contract address and the authorized address of the single log and Step S144 is executed, if the current state is the unauthorized state, an authorization record is correspondingly deleted according to the smart contract address and the authorized address of the single log and Step S144 is executed; if yes, then Step S1 is executed; and
Step S144: whether the NFT authorization type is a type of information subscribed to by a client is judged; if yes, contents of the synchronization operation of the single log are issued to the client, and a next single log continues to be extracted from the history logs for judgment until the history logs are traversed; if not, a next single log continues to be extracted from the history logs for judgment until the history logs are traversed.

In a preferred embodiment, after judging the log type of the single log, Step S14 further includes:
Step S145: if the log type is an NFT resource circulation type, the single log is parsed, and a smart contract execution code is queried according to a pre-stored smart contract address;
Step S146: a smart contract type is determined according to the smart contract execution code; if the smart contract is a first contract, a resource number record in the server is correspondingly deleted or added according to a parsing result of the single log, and Step S147 is executed; if the smart contract is a second contract, whether the single log is an NFT resource batch circulation log is judged; if yes, the single log is traversed to obtain a resource number, the resource number record in the present server is correspondingly deleted or added according to the resource number obtained by traversing and Step S147 is executed; if not, the resource number record in the present server is correspondingly deleted or added according to a parsing result of the single log and Step S147 is executed, in which
the first contract is specifically ERC721 contract; and
the second contract is specifically ERC1155 contract.

Step S147: whether the NFT resource circulation type is a type of information subscribed to by the client is judged; if yes, the contents of the synchronization operation of the single log are issued to the client, and a next single log continues to be extracted from the history logs for judgment until the history logs are traversed; if not, a next single log continues to be extracted from the history logs for judgment until the history logs are traversed.

Due to the adoption of the method for controlling the authority of NFT circulation data provided by the present invention, a user can withdraw authorized rights to achieve post-authorization authority management after resource authorization is achieved, thereby avoiding security hazards.

The following are apparatus embodiments of the present invention that can be used to execute method embodiments of the present invention. For details not disclosed in the apparatus embodiments of the present invention, please refer to the method embodiments of the present application.

An apparatus for controlling the authority of NFT circulation data according to an embodiment of the present invention is applied to a server encompassing blockchain middleware, a miner node, or a validation node, and the apparatus includes:
an instruction receiving module configured to receive an instruction initiated by a client;
an instruction judging module configured to judge the type of the instruction, trigger a first verification module if the instruction is an NFT resource authorization instruction, and trigger a second verification module if the instruction is an authorization withdrawal instruction;
the first verification module configured to verify the legitimacy of the NFT resource authorization instruction, if the verification passes, call a smart contract NFT resource authorization interface and trigger a resource authorization module, otherwise, return an error message and trigger the instruction receiving module;
the resource authorization module configured to judge whether an authorized address obtained from the NFT resource authorization instruction is a target address, if not, add a first data structure to a smart contract, complete an NFT resource authorization, record an authorization log, and trigger an instruction information synchronizing module; if yes, record an error log and trigger the instruction receiving module;
the second verification module configured to verify the legitimacy of the authorization withdrawal instruction, if the verification passes, broadcast the authorization withdrawal instruction, query a smart contract execution code according to a pre-stored smart contract address, and trigger a signature verifying module, otherwise, return an error message and trigger the instruction receiving module;
the signature verifying module configured to verify a signature of an authorization withdrawal transaction in the authorization withdrawal instruction using a pre-stored public key of the target address, if the verification passes, trigger a resource judging module, otherwise, return an error message and trigger the instruction receiving module;
the resource judging module configured to obtain an amount of additional resources and an amount of NFT resources owned by the target address from the authorization withdrawal instruction, check whether the amount of NFT resources owned by the target address is sufficient according to the amount of additional resources, if the amount of NFT resources owned by the target address is sufficient, trigger an authorization withdrawal module, otherwise, return an error message and trigger the instruction receiving module;
the authorization withdrawal module configured to judge whether an authorized address obtained from the authorization withdrawal instruction is the target address, if not, modify the first data structure according to a first preset mode, complete an authorization withdrawal, record an authorization withdrawal log, and trigger a resource amount deducting module; if yes, record an error log and trigger the instruction receiving module;
the resource amount deducting module configured to deduct the amount of additional resources from the amount of NFT resources owned by the target address to generate a corresponding authorization event, record an authorization withdrawal log, and trigger the instruction information synchronizing module; and
the instruction information synchronizing module configured to synchronize information generated by processing the instructions to other servers on the same blockchain, and trigger the instruction receiving module.

In a preferred embodiment, the instruction judging module further includes:
if the instruction is an instruction for obtaining the number of circulations of historical data, triggering a number obtaining module; if the instruction is an instruction for obtaining the amount of additional resources, triggering a resource amount obtaining module; if the instruction is an instruction for obtaining historical authorization data, triggering a third verification module; if the instruction is an instruction for obtaining the amount of NFT resources, triggering a fourth verification module;
the number obtaining module configured to obtain the number of circulations of historical data of the target address from state data of a current node running on the present server, issue the number of circulations of historical data to the client, and trigger the instruction receiving module;
the resource amount obtaining module configured to obtain the amount of additional resources from the state data of the current node, issue the amount of additional resources to the client, and trigger the instruction receiving module;
the third verification module configured to verify the legitimacy of the instruction for obtaining historical authorization data, if the verification passes, trigger an authorization data obtaining module, otherwise, return an error message and trigger the instruction receiving module;
the authorization data obtaining module configured to obtain historical authorization events of the target address from the state data of the current node, traverse the historical authorization events to obtain historical authorization data, issue the historical authorization data to the client, and trigger the instruction receiving module;
the fourth verification module configured to verify the legitimacy of the instruction for obtaining the amount of NFT resources, if the verification passes, trigger a resource obtaining module, otherwise, return an error message and trigger the instruction receiving module;
the resource obtaining module configured to obtain historical NFT resource circulation events of the target address from the state data of the current node, traverse the historical NFT resource circulation events to determine the amount of NFT resources owned by the target address, and issue the amount of NFT resources to the client.

In a preferred embodiment, for the operation of traversing the historical authorization events to obtain historical authorization data, and issuing the historical authorization data to the client, the method includes:
parsing the historical authorization events, and de-duplicating the parsed historical authorization events to obtain de-duplicated historical authorization events;
extracting a single authorization event from the de-duplicated historical authorization events, judging whether a smart contract address of the single authorization event and an authorized address are saved as historical authorization data; if the smart contract address and the authorized address are not saved, checking a current state of the authorized address; if the current state is an authorized state, saving the smart contract address and the authorized address as historical authorization data correspondingly; if the current state is an unauthorized state, continuing to extract a next single authorization event from the de-duplicated historical authorization events for judgment;
if the smart contract address and the authorized address are saved, continuing to extract a next single authorization event from the de-duplicated historical authorization events for judgment; and
issuing all historical authorization data saved to the client when the de-duplicated historical authorization events are traversed.

In a preferred embodiment, for the operation of traversing the historical NFT resource circulation events to determine the amount of NFT resources owned by the target address, and issuing the amount of NFT resources to the client, the method includes:
querying a smart contract execution code according to the pre-stored smart contract address;
determining a smart contract type based on the smart contract execution code; if the smart contract is a first contract, parsing the historical NFT resource circulation events, and performing event deduplication and resource number deduplication on the parsed historical NFT resource circulation events to obtain a first deduplication result;
extracting a single NFT resource circulation event from the first deduplication result, and judging whether an owner corresponding to the single NFT resource circulation event is the target address; if yes, judging whether the resource circulation amount of the single NFT resource circulation event is saved as historical resource circulation data, if the resource circulation amount of the single NFT resource circulation event is not saved, saving the resource circulation amount as historical resource circulation data; if the resource circulation amount of the single NFT resource circulation event is saved, continuing to extract a next single NFT resource circulation event from the first deduplication result for judgment;
if not, extracting a next single NFT resource circulation event from the first deduplication result for judgment; and
when the first deduplication result is traversed, obtaining the amount of NFT resources owned by the target address by computation based on all historical resource circulation data saved, and issuing the amount of NFT resources to the client.

In a preferred embodiment, for the operation of traversing the historical NFT resource circulation events to determine the amount of NFT resources owned by the target address, and issuing the amount of NFT resources to the client, the method includes:
querying a smart contract execution code according to the pre-stored smart contract address;
determining a smart contract type based on the smart contract execution code; if the smart contract is a second contract, obtaining and parsing NFT resource circulation events of the target type from the historical NFT resource circulation events, and performing event deduplication and resource number deduplication on the parsed NFT resource circulation events of the target type to obtain a second deduplication result;
extracting a single NFT resource circulation event from the second deduplication result, and obtaining the amount of remaining resources in the contract corresponding to the single NFT resource circulation event; judging whether the amount of remaining resources is greater than zero; if yes, issuing the amount of remaining resources as the amount of NFT resources owned by the target address to the client and ending traversing; if not, continuing to extract a next single NFT resource circulation event from the second deduplication result to obtain the amount of remaining resources for judgment until all NFT resource circulation events in the second deduplication result are traversed; and
when the amount of remaining resources in the contract corresponding to each NFT resource circulation event in the second deduplication result is equal to zero, returning a response that no NFT resource exits at the target address to the client.

In a preferred embodiment, the third verification module is specifically configured to:
calculate an owner public key that triggers the instruction for obtaining historical authorization data through signature data of the instruction for obtaining historical authorization data, verify a signature of the instruction for obtaining historical authorization data using the owner public key, if the verification passes, trigger the authorization data obtaining module, otherwise, return an error message and trigger the instruction receiving module.

In a preferred embodiment, the instruction judging module further includes:
triggering a fifth verification module if the instruction is an NFT resource minting instruction, and triggering a sixth verification module if the instruction is an NFT resource circulation instruction;
the fifth verification module configured to verify the legitimacy of the NFT resource minting instruction, if the verification passes, call a smart contract NFT resource minting interface and trigger a resource minting module, otherwise, return an error message and trigger the instruction receiving module;
the resource minting module configured to parse the NFT resource minting instruction to obtain a resource to be minted; judge whether the resource to be minted has been minted; if not, add a second data structure to the smart contract, complete NFT resource minting, record a minting log, and trigger an instruction synchronizing module; if yes, record an error log and trigger the instruction receiving module;
the instruction synchronizing module configured to synchronize information generated by the fifth verification module and the resource minting module to other servers on the same blockchain, and trigger the instruction receiving module;
the sixth verification module configured to verify the legitimacy of the NFT resource circulation instruction; if the verification passes, call a smart contract NFT resource circulation interface and trigger a contract resource judging module, otherwise, return an error message and trigger the instruction receiving module;
the contract resource judging module configured to parse the NFT resource circulation instruction to obtain an amount of resources to be circulated, an owner of the amount of resources to be circulated, and an address of a resource receiver; judge whether the amount of resources to be circulated exists in the smart contract; if the amount of resources to be circulated exists, trigger an owner judging module; if the amount of resources to be circulated does not exist, record an error log and trigger the instruction receiving module;
the owner judging module configured to judge whether the owner of the amount of resources to be circulated is an authorized address; if not, trigger a data structure judging module; if yes, send the amount of resources to be circulated to the address of the resource receiver and trigger a structure changing module;
the data structure judging module configured to judge whether the first data structure exists in the smart contract; if the first data structure exists, trigger a resource sending module; if the first data structure does not exist, record an error log and trigger the instruction receiving module;
the resource sending module configured to judge whether the first data structure is a target data structure; if yes, send the amount of resources to be circulated to the address of the resource receiver, and trigger the structure changing module; if not, record an error log and trigger the instruction receiving module;
the structure changing module configured to change the second data structure according to the address of the resource receiver, record a resource circulation log, and trigger the instruction synchronizing module; and
the instruction synchronizing module configured to synchronize information generated by the sixth verification module to the structure changing module to other servers on the same blockchain, and trigger the instruction receiving module.

In a preferred embodiment, the signature verifying module is specifically configured to:
extract signature information of the authorization withdrawal transaction from the authorization withdrawal instruction, and decrypt the signature information using the pre-stored public key of the target address to obtain a first hash value;
perform a hashing operation on text information of the authorization withdrawal transaction in the authorization withdrawal instruction to obtain a second hash value;
judge whether the first hash value and the second hash value are identical; if the first hash value and the second hash value are identical, pass the verification, and trigger the resource judging module, otherwise, return an error message and trigger the instruction receiving module.

In a preferred embodiment, the instruction judging module further includes: a block information synchronizing module is triggered if the instruction is a block information synchronization instruction:
the block information synchronizing module configured to parse the block information synchronization instruction to obtain block information of a block to be synchronized, judge whether the block to be synchronized has been synchronized according to the block information, if not, obtain and parse history logs of the block to be synchronized, synchronize information to the block to be synchronized according to a parsing result, and trigger the instruction receiving module.

In a preferred embodiment, the block information synchronizing module specifically includes:
a synchronization judging unit configured to parse the block information synchronization instruction to obtain block information of a block to be synchronized; judge whether the block to be synchronized has been synchronized according to the block information; if not, trigger a log extraction unit; if yes, trigger the instruction receiving module;
the log extraction unit configured to obtain history logs of the block to be synchronized, extract a single log from the history logs, and judge a log type of the single log; if the log type is an NFT authorization type, trigger a first processing unit; if the log type is an NFT resource circulation type, trigger a second processing unit;
the first processing unit configured to parse the single log, judge whether authorization information of the single log has been synchronized; if not, obtain a smart contract address and an authorized address of the single log, and check a current state of the authorized address obtained from the single log; if the current state is the authorized state, add an authorization record according to the smart contract address and the authorized address of the single log and trigger a subscription unit; if the current state is the unauthorized state, delete an authorization record according to the smart contract address and the authorized address of the single log and trigger the subscription unit; if yes, trigger the instruction receiving module;
the subscription unit configured to judge whether the NFT authorization type is a type of information subscribed to by the client; if yes, issue contents of the synchronization operation of the single log to the client, and continue to extract a next single log from the history logs for judgment until the history logs are traversed; if not, continue to extract a next single log from the history logs for judgment until the history logs are traversed;
the second processing unit configured to parse the single log, and query the smart contract execution code according to a pre-stored smart contract address;
a contract type judging unit configured to determine a smart contract type according to the smart contract execution code; if a smart contract is the first contract, correspondingly delete or add a resource number record in the present server according to a parsing result of the single log and trigger the subscription unit; if a smart contract is the second contract, judge whether the single log is an NFT resource batch circulation log; if yes, obtain the resource number by traversing the single log, correspondingly delete or add the resource number record in the present server according to the resource number obtained by traversing and trigger the subscription unit; if not, correspondingly delete or add the resource number record in the present server according to the parsing result of the single log and trigger the subscription unit; and
the subscription unit configured to judge whether the NFT resource circulation type is the type of information subscribed to by the client; if yes, issue the contents of the synchronization operation of the single log to the client, and continue to extract a next single log from the history logs for judgment until the history logs are traversed; if not, continue to extract a next single log from the history logs for judgment until the history logs are traversed.

The resource authorization module specifically includes:
a data structure judging unit configured to judge whether the authorized address obtained from the NFT resource authorization instruction is the target address; if not, judge whether a target data structure exists in the smart contract; if the target data structure exists, trigger a data structure modifying unit; if the target data structure does not exist, trigger a data structure adding unit; if yes, records an error log and trigger the instruction receiving module;
the data structure modifying unit configured to modify the target data structure according to a second preset mode to obtain a first data structure, complete an NFT resource authorization, record an authorization log, and trigger the instruction information synchronizing module; and
the data structure adding unit configured to add the first data structure to the smart contract, complete an NFT resource authorization, record an authorization log, and trigger the instruction information synchronizing module.

It is to be noted that, when the apparatus for controlling the authority of NFT circulation data provided by the above embodiment executes the method for controlling the authority of NFT circulation data, only the division of the above-described functional modules is taken as an example for illustration. In practice, the above-described functions may be allocated to different functional modules, i.e., the internal structure of the device may be divided into different functional modules as needed, to perform all or part of the above-described functions. In addition, the apparatus for controlling the authority of NFT circulation data provided by the above embodiment has the same concept as the embodiment for the method for controlling the authority of NFT circulation data, and its implementation process is detailed in the method embodiment, which will not be described in detail here.

The above serial number of embodiments of the present invention is for description only, and does not represent the advantages and disadvantages of the embodiments.

Due to the adoption of the apparatus for controlling the authority of NFT circulation data provided by the present invention, a user can withdraw authorized rights to achieve post-authorization authority management, thereby avoiding security hazards.

Embodiments of the present invention also provide a computer-readable storage medium having stored thereon a computer program which, when executed by a processor, implements the steps of any one of the preceding embodiment methods. The computer readable storage medium may include, but is not limited to, any type of disk including floppy disks, optical discs, DVDs, CD-ROMs, microdrivers, magneto-optical disks, ROMs, RAMs, EPROMS, EEPROMs, DRAMs, VRAMs, flash memory devices, magnetic or optical cards, nanosystems (including molecular memory ICs), or any type of medium or device suitable for storing instructions and/or data.

Embodiments of the present invention also provide a server, including a memory, a processor, and a computer program stored on the memory and executable by the processor. The computer program, when executed by the processor, implements the steps of any one of the preceding embodiment methods.

Embodiments of the present invention also provide a server, including a processor and a memory.

In the embodiments of the present invention, the processor is a control center of a computer system, can be a processor of a physical machine, or can also be a processor of a virtual machine. The processor may include one or more processing cores, such as a 4-core processor, or an 8-core processor. The processor may be implemented in a hardware form of at least one of DSP (Digital Signal Processing), FPGA (Field-Programmable Gate Array), or PLA (Programmable Logic Array). The processor may also include a main processor and a coprocessor. The main processor is a processor for processing data in an awake state, also known as a CPU (Central Processing Unit), and the coprocessor is a low power processor for processing data in a standby state.

The memory may include one or more computer-readable storage media, which may be non-transitory. The memory may also include a high-speed random access memory, and a non-volatile memory, such as one or more magnetic disk storage devices, and flash storage devices. In some embodiments of the present application, a non-transitory computer-readable storage medium in the memory is configured to store at least one instruction which is configured to be executed by a processor to implement a method in an embodiment of the present invention.

According to some embodiments of the present invention, the server further includes: a peripheral interface and at least one peripheral device. The processor, the memory and the peripheral interface may be connected by a bus or signal lines. Each peripheral device may be connected to the peripheral interface through a bus, signal lines, or a circuit board. In particular, the peripheral device includes: at least one of a display screen, a camera, and an audio circuit.

The peripheral interface can be used to connect at least one I/O (Input/Output) related peripheral device to the processor and the memory. In some embodiments of the present application, the processor, the memory, and the peripheral interface are integrated on the same chip or circuit board. In some other embodiments of the present application, any one or two of the processors, the memory, and the peripheral interface may be implemented on separate chips or circuit boards. The embodiments of the present invention are not particularly limited thereto.

A display screen is used to display a UI (User Interface). The UI may include a graphic, a text, an icon, a video and any combination thereof. When the display screen is a touch display screen, the display screen also has the ability to capture a touch signal at or above the surface of the display screen. The touch signal may be input as a control signal to the processor for processing. At this point, the display screen may also be used to provide a virtual button and/or a virtual keyboard, also referred to as a soft button and/or a soft keyboard. In some embodiments of the present application, there may be one display screen provided on the front panel of the server. In other embodiments of the present application, there may be at least two display screens provided on different surfaces of the server separately or in a folded design. In still other embodiments of the present application, the display screen may be a flexible display screen, provided on a curved surface or a folded surface of the server. Even more, the display screen may be set to be in a non-rectangular irregular shape, i.e., a special-shaped screen. The display screen may be manufactured using a Liquid Crystal Display (LCD), an OLED (Organic Light-Emitting Diode), or the like.

A camera is used to capture an image or a video. Optionally, the camera includes a front camera and a rear camera. Typically, the front camera is provided on the front panel of the client and the rear camera is provided on the back of the client. In some embodiments, there are at least two rear cameras, each of which is any one of a main camera, a depth-of-field camera, a wide-angle camera, and a telephoto camera, so that the main camera and the depth-of-field camera are combined to achieve a background blurring function, and the main camera and the wide-angle camera are combined to achieve panorama photographing, and a VR (Virtual Reality) photographing function or other combined photographing function. In some embodiments of the present application, the camera may further include a flash. The flash may be a single-color temperature flash or a dual-color temperature flash. The dual-color temperature flash refers to a combination of a warm light flash and a cool light flash that can be used for light compensation at different color temperatures.

The audio circuit may include a microphone and a loudspeaker. The microphone is used to collect sound waves of the user and the environment and convert the sound waves into electrical signals that are input to the processor for processing. For the purpose of stereo capture or noise reduction, there may be multiple microphones that are provided at different parts of the server, respectively. The microphone may also be a microphone array or an omnidirectional microphone.

A power supply is used to power various components in the server. The power supply may be an alternating current power supply, a direct-current power supply, a disposable battery, or a rechargeable battery. When the power supply includes a rechargeable battery, the rechargeable battery may be a wired rechargeable battery or a wireless rechargeable battery. The wired rechargeable battery is a battery charged by a wired line, and the wireless rechargeable battery is a battery charged by a wireless coil. The rechargeable battery may also be used to support fast charge technology.

The illustrated block diagram of the client in embodiments of the present invention does not constitute a limitation of the server, and the server may include more or fewer components than illustrated, or combine certain components, or employ a different arrangement of components.

In the present application, the terms “first”, “second”, etc., are used for descriptive purposes only and are not to be construed as indicating or implying relative importance or order; the term “plurality” refers to two or more, unless expressly specified otherwise. The terms “mount”, “couple”, “connect”, “secure”, etc., should all be understood broadly. For instance, “connect” can refer to fixed connection, detachably connection, or integrally connection; “couple” can refer to direct coupling or indirect coupling through an intermediate medium. Those skilled in the art can understand the specific meanings of these terms in the present application based on specific circumstances.

In the present invention, it needs to be understood that the term “upper”, “lower” or the like indicates an orientation or positional relationship based on the orientation or positional relationship shown in the drawings, is only used to facilitate the description of the present application and simplicity of description, and does not indicate or imply that the indicated device or unit must have a particular orientation, be constructed and operate in a particular orientation, and therefore, are not to be construed as limiting the present invention.

The above are only specific embodiments of the present invention, but the scope of protection of the present invention is not limited thereto. Those skilled in the art may readily contemplate variations or substitutions which should all fall within the scope of protection of the present invention. Therefore, the equivalent variations made in accordance with the claims of the present invention remain within the scope of the present invention.

1. A method for controlling an authority of NFT circulation data, wherein the method comprises the following steps:
S1) receiving, by a server, an instruction initiated by a client;
S2) judging, by the server, a type of the instruction, executing Step S3 if the instruction is for an NFT resource authorization instruction, while executing Step S5 if the instruction is for an authorization withdrawal instruction;
S3) verifying, by the server, a legitimacy of the NFT resource authorization instruction; if a verification passes, calling a smart contract NFT resource authorization interface then executing Step S4; otherwise, returning an error message then executing Step S1;
S4) judging, by the server, whether an authorized address obtained from the NFT resource authorization instruction is a target address; if not, adding a first data structure to a smart contract, completing an NFT resource authorization, and recording an authorization log, then executing Step S10; if yes, recording an error log then executing Step S1;
S5) verifying, by the server, a legitimacy of the authorization withdrawal instruction; if a verification passes, broadcasting the authorization withdrawal instruction, and querying a smart contract execution code according to a pre-stored smart contract address, then executing Step S6; otherwise, returning an error message then executing Step S1;
S6) verifying, by the server, a signature of an authorization withdrawal transaction in the authorization withdrawal instruction using a pre-stored public key of the target address; if a verification passes, then executing Step S7, otherwise, returning an error message then executing Step S1;
S7) obtaining, by the server, an amount of additional resources and an amount of NFT resources owned by the target address from the authorization withdrawal instruction; checking whether the amount of NFT resources owned by the target address is sufficient according to the amount of additional resources; if the amount of NFT resources owned by the target address is sufficient, executing Step S8, otherwise, returning an error message and executing Step S1;
S8) judging, by the server, whether an authorized address obtained from the authorization withdrawal instruction is the target address; if not, modifying the first data structure according to a first preset mode, completing an authorization withdrawal, and recording an authorization withdrawal log, then executing Step S9; if yes, recording an error log and executing Step S1;
S9) deducting, by the server, the amount of additional resources from the amount of NFT resources owned by the target address to generate a corresponding authorization event, and recording an authorization withdrawal log, then executing Step S10; and
S10) synchronizing, by the server, information generated by processing the instructions to other servers on the same blockchain, then executing Step S1.

2. The method according to claim 1, wherein Step S2 further comprises:
executing Step S11 if the instruction is an instruction for obtaining a number of circulations of historical data, executing Step S12 if the instruction is an instruction for obtaining the amount of additional resources, executing Step S13 if the instruction is an instruction for obtaining historical authorization data, and executing Step S15 if the instruction is an instruction for obtaining the amount of NFT resources;
S11) obtaining, by the server, the number of circulations of historical data of the target address from state data of a current node running on the present server, and issuing the number of circulations of historical data to the client, then executing Step S1;
S12) obtaining, by the server, the amount of additional resources from the state data of the current node, and issuing the amount of additional resources to the client, then executing Step S1;
S13) verifying, by the server, a legitimacy of the instruction for obtaining historical authorization data; if a verification passes, then executing Step S14, otherwise, returning an error message and executing Step S1;
S14) obtaining, by the server, historical authorization events of the target address from the state data of the current node, traversing the historical authorization events to obtain historical authorization data, and issuing the historical authorization data to the client, then executing Step S1;
S15) verifying, by the server, a legitimacy of the instruction for obtaining the amount of NFT resources; if a verification passes, then executing Step S16, otherwise, returning an error message and executing Step S1; and
S16) obtaining, by the server, historical NFT resource circulation events of the target address from the state data of the current node, traversing the historical NFT resource circulation events to determine the amount of NFT resources owned by the target address, and issuing the amount of NFT resources to the client, then executing Step S1.

3. The method according to claim 2, wherein for traversing the historical authorization events to obtain historical authorization data, and issuing the historical authorization data to the client, the method comprises:
parsing the historical authorization events, and de-duplicating the historical authorization events parsed to obtain de-duplicated historical authorization events;
extracting a single authorization event from the de-duplicated historical authorization events; judging whether a smart contract address of the single authorization event and an authorized address are saved as historical authorization data; if the smart contract address and the authorized address have been not yet saved, checking a current state of the authorized address; if the current state is an authorized state, saving the smart contract address and the authorized address as historical authorization data correspondingly, while if the current state is an unauthorized state, continuing to extract a next single authorization event from the de-duplicated historical authorization events for judgment;
if the smart contract address and the authorized address have been saved, continuing to extract a next single authorization event from the de-duplicated historical authorization events for judgment; and
issuing all historical authorization data saved to the client after the de-duplicated historical authorization events are traversed.

4. The method according to claim 2, wherein for traversing the historical NFT resource circulation events to determine the amount of NFT resources owned by the target address, and issuing the amount of NFT resources to the client, the method comprises:
querying a smart contract execution code according to a pre-stored smart contract address;
determining, based on the smart contract execution code, a smart contract type; if the smart contract is a first contract, parsing the historical NFT resource circulation events, and performing event deduplication and resource number deduplication on the historical NFT resource circulation events parsed to obtain a first deduplication result;
extracting a single NFT resource circulation event from the first deduplication result; judging whether an owner corresponding to the single NFT resource circulation event is the target address; if yes, judging whether a resource circulation amount of the single NFT resource circulation event is saved as historical resource circulation data; if the resource circulation amount of the single NFT resource circulation event has been not yet saved, saving the resource circulation amount as historical resource circulation data; if the resource circulation amount of the single NFT resource circulation event has been saved, continuing to extract a next single NFT resource circulation event from the first deduplication result for judgment;
if not, continuing to extract a next single NFT resource circulation event from the first deduplication result for judgment; and
obtaining, based on all historical resource circulation data saved, the amount of NFT resources owned by the target address by computation, and issuing the amount of NFT resources to the client after the first deduplication result is traversed.

5. The method according to claim 2, wherein for traversing the historical NFT resource circulation events to determine the amount of NFT resources owned by the target address, and issuing the amount of NFT resources to the client, the method comprises:
querying a smart contract execution code according to a pre-stored smart contract address;
determining, based on the smart contract execution code, a smart contract type; if the smart contract is a second contract, obtaining NFT resource circulation events of a target type from the historical NFT resource circulation events, parsing the NFT resource circulation events of the target type, and performing event deduplication and resource number deduplication on the NFT resource circulation events parsed of the target type to obtain a second deduplication result;
extracting a single NFT resource circulation event from the second deduplication result, and obtaining an amount of remaining resources in the contract corresponding to the single NFT resource circulation event; judging whether the amount of remaining resources is greater than zero; if yes, issuing the amount of remaining resources as the amount of NFT resources owned by the target address to the client and ending traversing, if not, continuing to extract a next single NFT resource circulation event from the second deduplication result to obtain the amount of remaining resources for judgment until all NFT resource circulation events in the second deduplication result are traversed; and
returning a response that no NFT resource exits at the target address to the client when all of the amount of remaining resources in the contract corresponding to each NFT resource circulation event in the second deduplication result are equal to zero.

6. The method according to claim 2, wherein Step S13 further comprises:
calculating, by the server, an owner public key that triggers the instruction for obtaining historical authorization data through signature data of the instruction for obtaining historical authorization data; and verifying a signature of the instruction for obtaining historical authorization data using the owner public key; if a verification passes, executing Step S14, otherwise, returning an error message and executing Step S1.

7. The method according to claim 1, wherein Step S2 further comprises:
executing Step S2′-1 if the instruction is an NFT resource minting instruction; executing Step S2′-4 if the instruction is an NFT resource circulation instruction;
S2′-1) verifying, by the server, a legitimacy of the NFT resource minting instruction; if a verification passes, calling a smart contract NFT resource minting interface, then executing Step S2′-2, otherwise, returning an error message and executing Step S1;
S2′-2) parsing, by the server, the NFT resource minting instruction to obtain a resource to be minted; judging whether the resource to be minted has been minted; if not, adding a second data structure to the smart contract, completing NFT resource minting, and recording a minting log, then executing Step S2′-3, if yes, recording an error log then executing Step S1;
S2′-3) synchronizing, by the server, information generated in Step S2′-1 to Step S2′-2 to other servers on the same blockchain, then executing Step S1;
S2′-4) verifying, by the server, a legitimacy of the NFT resource circulation instruction; if a verification passes, calling a smart contract NFT resource circulation interface then executing Step S2′-5, otherwise, returning an error message then executing Step S1;
S2′-5) parsing, by the server, the NFT resource circulation instruction to obtain an amount of resources to be circulated, an owner of the amount of resources to be circulated, and an address of a resource receiver; judging whether any amount of resources to be circulated exists in the smart contract; if the amount of resources to be circulated exists, executing Step S2′-6, while if the amount of resources to be circulated does not exist, recording an error log then executing Step S1;
S2′-6) judging, by the server, whether the owner of the amount of resources to be circulated is the authorized address; if not, executing Step S2′-7; if yes, sending the amount of resources to be circulated to the address of the resource receiver, then executing Step S2′-9;
S2′-7) judging, by the server, whether the first data structure exists in the smart contract; if the first data structure exists, then executing Step S2′-8; if the first data structure does not exist, recording an error log then executing Step S1;
S2′-8) judging, by the server, whether the first data structure is a target data structure; if yes, sending the amount of resources to be circulated to the address of the resource receiver, then executing Step S2′-9; if not, recording an error log then executing Step S1;
S2′-9) changing, by the server, the second data structure according to the address of the resource receiver, and recording a resource circulation log, then executing step S2′-10; and
S2′-10) synchronizing, by the server, information generated in Step S2′-4 to Step S2′-9 to other servers on the same blockchain, then executing Step S1.

8. The method according to claim 1, wherein Step S6 further comprises the following steps:
S61) extracting, by the server, signature information of the authorization withdrawal transaction from the authorization withdrawal instruction, and decrypting the signature information using the pre-stored public key of the target address to obtain a first hash value;
S62) performing, by the server, a hashing operation on text information of the authorization withdrawal transaction in the authorization withdrawal instruction to obtain a second hash value; and
S63) judging, by the server, whether the first hash value and the second hash value are identical; if the first hash value and the second hash value are identical, passing the verification, then executing Step S7, otherwise, returning an error message then executing Step S1.

9. The method according to claim 1, wherein Step S2 further comprises: executing Step S17 if the instruction is a block information synchronization instruction:
parsing, by the server, the block information synchronization instruction to obtain block information of a block to be synchronized; judging whether the block to be synchronized has been synchronized according to the block information; if not, obtaining and parsing history logs of the block to be synchronized, and synchronizing information to the block to be synchronized according to a parsing result; if yes, then executing Step S1.

10. The method according to claim 9, wherein Step S17 comprises the following steps:
S171) parsing, by the server, the block information synchronization instruction to obtain block information of a block to be synchronized; judging whether the block to be synchronized has been synchronized according to the block information; if not yet, then executing Step S172; if yes, then executing Step S1;
S172) obtaining, by the server, history logs of the block to be synchronized, extracting a single log from the history logs, and judging a log type of the single log;
S173) parsing the single log and judging whether authorization information of the single log has been synchronized if the log type is an NFT authorization type; if not yet, obtaining a smart contract address and an authorized address of the single log, checking a current state of the authorized address obtained from the single log, if the current state is an authorized state, adding an authorization record correspondingly according to the smart contract address and the authorized address of the single log then executing Step S174; if the current state is an unauthorized state, deleting an authorization record correspondingly according to the smart contract address and the authorized address of the single log then executing Step S174; if yes, executing Step S1; and
S174) judging whether the NFT authorization type is a type of information subscribed to by the client; if yes, issuing contents of a synchronization operation of the single log to the client, and continuing to extract a next single log from the history logs for judgment until the history logs are traversed; if not, continuing to extract a next single log from the history logs for judgment until the history logs are traversed.

11. The method according to claim 10, wherein after judging the log type of the single log, the method further comprises the following steps:
S175) parsing the single log and querying a smart contract execution code according to a pre-stored smart contract address if the log type is an NFT resource circulation type;
S176) determining a smart contract type according to the smart contract execution code; if the smart contract is the first contract, deleting or adding a resource number record in the present server correspondingly according to a parsing result of the single log, then executing Step S177; if the smart contract is the second contract, judging whether the single log is an NFT resource batch circulation log; if yes, obtaining a resource number by traversing the single log, deleting or adding the resource number record in the present server correspondingly according to the resource number obtained by traversing, then executing Step S177; if not, deleting or adding the resource number record in the present server correspondingly according to the parsing result of the single log, then executing Step S177; and
S177) judging whether the NFT resource circulation type is the type of information subscribed to by the client; if yes, issuing contents of a synchronization operation of the single log to the client, and continuing to extract a next single log from the history logs for judgment until the history logs are traversed; if not, continuing to extract a next single log from the history logs for judgment until the history logs are traversed.

12. The method according to claim 1, wherein Step S4 further comprises the following steps:
S4-1) judging, by the server, whether the authorized address obtained from the NFT resource authorization instruction is the target address; if not, judging whether a target data structure exists in the smart contract, if the target data structure exists, then executing Step S4-2; if the target data structure does not exist, executing Step S4-3; if yes, recording an error log then executing Step S1;
S4-2) modifying, by the server, the target data structure according to a second preset mode to obtain a first data structure, completing an NFT resource authorization, and recording an authorization log, then executing Step S10; and
S4-3) adding, by the server, the first data structure to the smart contract, completing an NFT resource authorization, and recording an authorization log, then executing Step S10.

13. An apparatus for controlling an authority of NFT circulation data, wherein the apparatus comprises:
a module for receiving an instruction initiated by a client;
a module for judging a type of the instruction, which triggers a first module for performing verification if the instruction is an NFT resource authorization instruction, and triggers a second module for performing verification if the instruction is an authorization withdrawal instruction;
the first module for performing verification configured to verify a legitimacy of the NFT resource authorization instruction, call a smart contract NFT resource authorization interface if a verification passes and trigger a module for performing a resource authorization, otherwise, return an error message and trigger the module for receiving;
the module for performing a resource authorization configured to judge whether an authorized address obtained from the NFT resource authorization instruction is a target address; if not, add a first data structure to a smart contract, complete an NFT resource authorization, record an authorization log, and trigger a module for performing instruction information synchronizing; if yes, record an error log and trigger the module for receiving;
the second module for performing verification configured to verify a legitimacy of the authorization withdrawal instruction; if a verification passes, broadcast the authorization withdrawal instruction, query a smart contract execution code according to a pre-stored smart contract address, and trigger a module for verifying signature, otherwise, return an error message and trigger the module for receiving;
the module for verifying signature configured to verify a signature of an authorization withdrawal transaction in the authorization withdrawal instruction using a pre-stored public key of the target address; if a verification passes, trigger a module for judging resource, otherwise, return an error message and trigger the module for receiving;
the module for judging resource configured to obtain an amount of additional resources and an amount of NFT resources owned by the target address from the authorization withdrawal instruction; check whether the amount of NFT resources owned by the target address is sufficient according to the amount of additional resources; if the amount of NFT resources owned by the target address is sufficient, trigger a module for performing authorization withdrawal, otherwise, return an error message and trigger the module for receiving;
the module for performing authorization withdrawal configured to judge whether an authorized address obtained from the authorization withdrawal instruction is the target address; if not, modify a first data structure according to a first preset mode, complete an authorization withdrawal, record an authorization withdrawal log, and trigger a module for performing resource amount deducting; if yes, record an error log and trigger the module for receiving;
the module for performing resource amount deducting configured to deduct the amount of additional resources from the amount of NFT resources owned by the target address to generate a corresponding authorization event, record an authorization withdrawal log, and trigger the module for performing instruction information synchronizing; and
the module for performing instruction information synchronizing configured to synchronize information generated during processing the instructions to other servers on the same blockchain, and trigger the module for receiving.

14. A server or a computer-readable storage medium, the server comprising a memory, a processor, and a computer program stored on the memory and running on the processor, wherein
the processor, when executing the computer program, implements the steps of the method according to claim 1; and
the computer-readable storage medium stores thereon a computer program which, when executed by the processor, implements the steps of the method according to claim 1.
